(19) United States
(12) Patent Application Publication
(10) Pub. No.: US 2017/0198860 A1
(43) Pub. Date: Jul. 13, 2017

(54) CONNECTOR FOR A DECORATIVE ELEMENT

(71) Applicant: D. Swarovski KG, Wattens (AT)

(72) Inventors: Christof GAPP, Aldrans (AT); Florian LECHTHALER, Igls (AT)

(21) Appl. No.: 15/469,723

(22) Filed: Mar. 27, 2017

Related U.S. Application Data
(63) Continuation of application No. PCT/AT2014/050235, filed on Oct. 7, 2014.

(51) Int. Cl. F16M 13/02; B42F 1/08; A47F 7/02; A44C 17/02; A47F 5/00

(52) U.S. Cl. CPC F16M 13/02; A44C 17/0208; A47F 5/0006; A47F 7/02; B42F 1/08

(57) ABSTRACT

Disclosed is a connector (1) for mounting a decorative element (2) on a structure (3), comprising an insertion guide (4), a support zone (5) for the decorative element (2), and a retaining structure (10); two substantially parallel legs (6, 7) adjoin the support zone (5), and the insertion guide (4) projects from a first of the two substantially parallel legs (6) at a predefined angle.

The present invention concerns a connector for mounting a decorative element to a structure having the features of the classifying portion of claim 1 and a set comprising a connector and a decorative element, preferably a gemstone. The invention also concerns a set having a decorative element with a through hole, as well as an installation, preferably an installation comprising a wire mesh, with at least one set mounted thereto.

Paperclips which can be used in a double-sided fashion, as shown for example in U.S. Pat. No. 5,170,535, and paperclips for simultaneously holding two separate sheafs of paper, as shown for example in U.S. Pat. No. 4,300,268, are known in the state of the art. Such clips could be used in a manner which is not in accordance with the general concept involved here, as a connector for mounting a decorative element to a structure, in which case however application of the decorative element to the clip used in that way as well as fitting the clip to a structure would have to be effected only with a lot of trouble and with a great deal of time and work. A clip for clipping together for example paper and for holding for example keys is shown in U.S. Pat. No. 4,658,479. A use, which is not in accordance with the general concept involved here, of such a clip for mounting a decorative element to a structure would in this case also involve extremely complicated handling and a large amount of work and time. In addition it would not be possible with the stated clips to guarantee adequate mechanical securing of a decorative element to a structure.

The object of the invention is to provide a connector which is improved over the state of the art for mounting a decorative element to a structure and a set comprising such a connector and a decorative element, preferably a gemstone, which are suitable in particular for mounting a plurality of such sets to a structure.

That object is attained by a connector having the features of claim 1 and a set comprising such a connector and a decorative element. Advantageous configurations of the invention are defined in the appendant claims.

By virtue of the fact that the insertion guide projects at a predetermined angle from a first one of the two substantially parallel legs an insertion guide with a double function can be implemented in a simple fashion for fitting the connector to a structure quickly, in a mechanical secure fashion and in such a way that it can carry a load, as well as without using a tool, and for easily and quickly fitting a decorative element to the connector in a mechanically secure and damage-free fashion without involving a tool. The angle in that respect can be between 10° and 80°, preferably between 20° and 70° and quite preferably between 30° and 60°. An angle range selected in that way makes it possible to provide an insertion guide which at the same time is distinguished by particular ease of suspensively fitting a decorative element in a connector and an equally particular ease in suspensively fitting the connector to a structure.

The connector can be an elastically deformable workpiece, for example a suitably shaped metal, for example a wire of spring steel, but also a suitable plastic. The function of the connector according to the invention can be ensured by the choice of a suitable material.

The decorative element in that case can be a gemstone, for example a ground or unground glass body or crystal. The decorative element preferably has a through hole, the shaping of which can also be adapted to the support region. Alternatively the decorative element may also have a mounting with an eye for mounting it to a connector.

The structure to which the connectors are anchored can be for example a substantially one-dimensional structure of wire, a two- or three-dimensional wire mesh, a cable or also for example two adjacent holes having a limb-shaped structure therebetween. Preferably the structure includes a possible way of hanging up a plurality of connectors so that installation objects involving a large surface area, for example with between about 500,000 and 1,000,000 connectors are made possible in time-saving fashion. The structures and installation objects can be disposed outside and also inside buildings. Use in the outside and the effects linked thereto of wind and other weather influences means that secure mounting of the connector to the structure—and also of the decorative element in the connector—is to be ensured, which is achieved by a connector according to the invention. It will be appreciated that other mounting means are also possible as the structure.

The fact that two parallel legs adjoin the support region of the connector makes it possible to ensure a turn angle for the support region through substantially 180°. In that case the support region can be of a constant curvature, but it is also conceivable for it to be of a configuration involving a non-constant curvature. The reference to legs which are substantially parallel in adjoining relationship with the support region can in other words also be used to denote a respective straight portion of the connector, adjoining the notional ends of the support region.

The provision of a retaining structure can ensure that unwanted disengagement of the connector from its suspension on the structure does not occur. In that way also it is possible to prevent a transverse loading, for example due to the action of wind or vibration of the structure, on the connector in the mounted condition.

In addition to better mechanical securing of the connector and therewith a decorative element mounted to the connector on a structure, the configuration of the retaining structure with a plurality of, preferably two, retaining regions can also ensure an increased safeguard against theft of the connector with a decorative element fixed thereto. In that case for example the retaining structure can have two retaining regions, whereby a particularly secure mechanical hold is made possible without mounting of the connector to the structure or also the decorative element in the connector being made more difficult.

It can be provided that approximately half of the area afforded by the connector is occupied by the retaining structure. It is preferably provided that the connector is in one piece.

It can be particularly advantageous if the retaining structure, the support region and the substantially parallel legs substantially define a closed area and the insertion guide is adapted to project from that area. In this respect the closed area can be interpreted as meaning the area defined by the projection of the connector into a plane. In that case the quantity of points, which is enclosed by that notional substantially closed boundary line, can be interpreted as the inner region of the connector surface area. Thus a structure protruding outwardly in projection can be interpreted as projecting from that surface. An insertion guide of such a configuration significantly simplifies suspending the connector to a structure and suspending a decorative element to the connector and, in the case of large object installations, results in an enormous time saving upon construction thereof.

It is preferably provided in that case that the insertion guide has an uncurved portion which is arranged at a free end of the connector and which is angled from the first of the two substantially parallel legs in a range of between 10° and 80°, preferably between 20° and 70° and quite preferably between 30° and 60°. Because the insertion guide is provided at a free end of the connector manufacture of the connector can be simplified. In that respect the reference to free end is used to mean substantially the end point of the connector wire, but it is also possible that this involves a free end of a wire structure which has been folded over. The provision of the insertion guide at a first of the two substantially parallel legs can ensure that, when the connector is mounted to a structure or when a decorative element is mounted to the connector, the straight portions adjoining the support region are spread open and thus the connector is opened. The opened connector can be closed again by virtue of the resilient material. Because the insertion guide has an uncurved portion which is angled in a range of between 10° and 80°, preferably between 20° and 70° and quite preferably between 30° and 60°, this can provide a particularly simple and effective configuration for the insertion guide. The dimensions of the uncurved portion in that case can be adapted to the decorative element or the through hole thereof. Because the uncurved portion is angled at between 10° and 80°, preferably between 20° and 70° and quite preferably between 30° and 60° away from the first of the two substantially parallel legs, that can provide for a particularly effective configuration for the insertion guide.

It can be advantageous in that respect if the second of the substantially parallel legs goes into a first retaining region. That makes it possible for the connector to be of a compact construction. With a suitable configuration of the first retaining region it can also be made possible for the part of the structure projecting through the connector to be moved past the support region when fitting the connector to a structure, which for example can permit easy mounting of a connector provided with a decorative element.

In a preferred embodiment it can be provided that the first retaining region has at least a first curved portion and a second curved portion in opposite relationship to the first portion. Such a configuration of the first retaining region can permit the provision of a closed retaining structure which allows the part of the connector with the support region to be spatially separated from the part of the connector with the retaining structure. That can permit the provision of a configuration which is particularly simple to manufacture for the retaining structure, with a high degree of mechanical security. An oppositely directed curvature of the curved portions makes it possible in that way to provide a closed-off portion of the connector, wherein hanging fitment into the retaining structure can be facilitated by the curvature of the second curved portion.

It can be advantageous in that respect if an uncurved portion is disposed between the first and the second curved portions of the first retaining region, which portion is arranged parallel to the substantially parallel legs. That makes it possible to provide the connector with a closed shape with substantially parallel legs adjoining the support region and of unequal lengths. In addition that makes it possible to ensure any desired dimensioning of the first retaining region and thus the retaining structure.

It has also proven to be advantageous if the first curved portion of the first retaining region has a curvature with a radius of curvature equal to the radius of curvature of the support region and a turn angle of substantially 180°. The equality in terms of the radii of curvature and thus substantially the dimensions of the support region and the first curved portion of the first retaining region makes it possible to provide a closed connector shape and in particular a closed connector shape without a spiral form. This also makes it possible for the apex points of the support region and the first curved portion to come to lie on a straight line substantially parallel to the substantially parallel legs, whereby this can involve advantageous distribution of the forces to a connector which is used according to the invention. The turn angle of substantially 180° makes it possible to achieve a preferred configuration for the connector.

It can also be further provided that the second curved portion of the first retaining region has a curvature with a radius of curvature less than the radius of curvature of the first curved portion and a turn angle of substantially 180°. A smaller radius of curvature of the second curved portion makes it possible if desired to achieve a flat configuration for the first retaining region and thus in particular to attain the provision of the first retaining region in the form of a substantially flat spiral shape. A turn angle of substantially 180° makes it possible to provide a region which is closed off in relation to the rest of the connector.

It has proven to be particularly advantageous if the support region and at least the first curved region of the first retaining region lie substantially in one plane. In other words the osculating plane of the support region and the osculating plane of the first curved region are coplanar in one plane. That can make it possible to design a connector involving a closed flat shape in respect of its notional boundary line. It is preferably provided that the insertion guide or the angled uncurved portion thereof is disposed jointly with the support region and at least the first curved region of the first retaining region in a plane.

It can be particularly advantageously provided that the second retaining region has a free end extending out of the above-described plane. In other words a free end of the second retaining region with the common osculating plane of the support region and at least of the first curved region of the first retaining region includes an angle differing from 0° and 180° respectively. The fact that the retaining structure is at least portion-wise of a non-flat configuration in that way makes it possible to achieve a mechanical safeguard against release thereof in a simple fashion and without complicating the process for suspensively mounting the connector to the structure.

It has proven to be advantageous if the second retaining region has a curved portion adjoining the first retaining region, preferably by way of an uncurved portion. It is possible in that way in a simple fashion to provide a region separate from the first retaining region. In addition insertion into the second retaining region can be simplified by virtue of the provision of a curved portion. The provision of an uncurved portion between the first and second retaining regions makes it possible for the curved portions thereof to be brought closer together, which results in the retaining structure being of a mechanically more stable structure and provides for better utilization of the area of the connector, occupied by the retaining structure. In that way it is also optionally possible to adapt the configuration of the retaining structure to the respective structure, for example also already in the run-up to production.

In a preferred embodiment it can be provided that the second retaining region has a first end which bears resiliently against the first retaining region. That can permit a mechanical closure safeguard for the retaining structure.

It can further be provided as advantageous if the curved portion of the second retaining region has a curvature with a radius of curvature less than the radius of curvature of the second curved portion of the first retaining region and a turn angle of between 90° and 180°. By virtue of the smaller radius of curvature the curved portion of the second retaining region can be arranged within the first retaining region and thus also, if desired, it is possible for the second retaining region to be of a flat configuration. In that case, as in all other curved portions, the radius of curvature can be constant. The possibility however should here too not be excluded that the radius of curvature over the curved portion remains non-constant. In addition the smaller radius of curvature can make it possible for the apex point of the curvature of the curved portion of the second retaining region to lie on a straight connecting line to the apex points of the support region and the first curved portion of the first retaining region, and thus this can provide advantageous distribution of the tensile forces acting on a mounted connector. A turn angle of between 90° and 180° thus makes it possible, also in combination with the radius of curvature, to ensure the provision of a closed region.

It has proven to be particularly advantageous if the end of the insertion guide, that is arranged on the substantially parallel leg, bears preferably resiliently against the first retaining region. In that respect, the reference to the end of the insertion guide, that is arranged at the substantially parallel leg, is used to denote for example the end of the uncurved portion angled from the first of the two legs, that is in opposite relationship to the free end thereof. The resilient contact which is afforded by the straight portions, that so-to-speak are in oppositely disposed butting relationship, of the first of the substantially parallel legs and the straight portion arranged between the first and second curved portions of the first retaining region, or the spreading thereof, can act in opposition to the opening of the connector and by virtue of the closure safeguard, can allow secure mounting of a decorative element to a connector.

Protection is also claimed for a set comprising a connector according to the invention and a decorative element, preferably a gemstone. The provision of such a set can afford a pre-assembled unit of a connector and a decorative element which allows particularly simple, fast and mechanical secure fitment to a structure without a tool. The use of a connector according to the invention can thus provide an inexpensive, secure and weather-resistant set which is easy to manufacture.

It has proven to be particularly advantageous if the decorative element has a through hole for mounting the decorative element in the connector, in that way the decorative element can be easily fixed to the connector. In that case the configuration of the through hole can be adapted to the insertion guide and/or the support region. The through hole can be provided for example on the decorative element itself. As an alternative thereto the decorative element can have a suitable mounting having an eye, by way of which the decorative element is then fixed in the connector.

Protection is further claimed for an installation, preferably an installation comprising a wire mesh, having at least one set mounted thereto. Such an installation includes the structure for mounting the connector, wherein the structure can be for example in the form of a two- or three-dimensional wire mesh. In that respect the installation can be produced by hanging it with a multiplicity of sets according to the invention comprising a connector with a decorative element, in a particularly simple fashion and involving a small amount of work and time.

Further details and advantages of the present invention are described in greater detail hereinafter by means of the specific description with reference to the embodiments by way of example illustrated in the drawing in which:

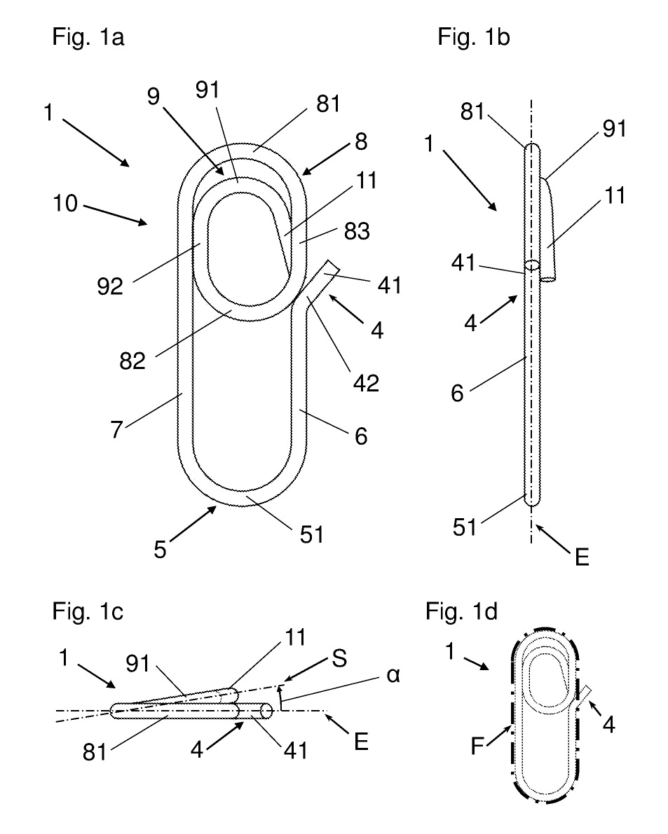

FIG. 1a shows a front view of the connector,

FIG. 1b shows a side view of the connector,

FIG. 1c shows a view from above on to the connector,

FIG. 1d shows a further front view of the connector,

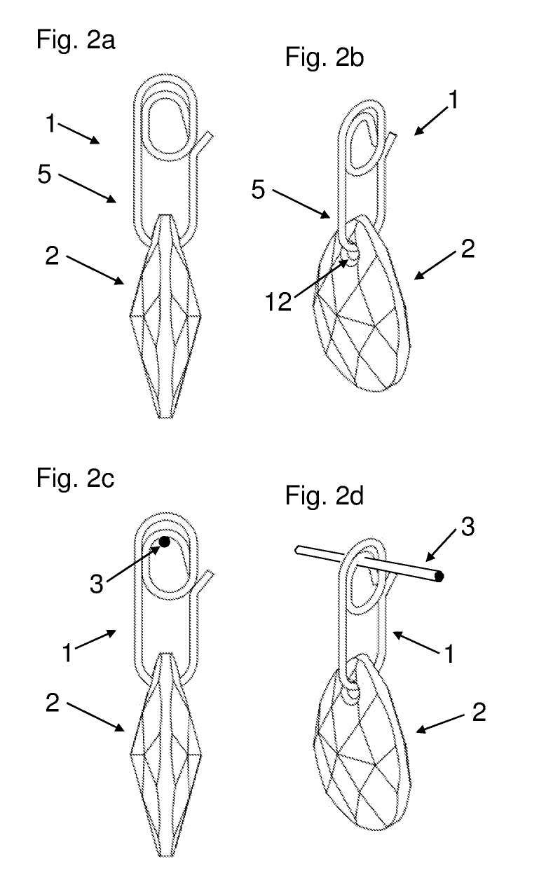

FIG. 2a shows a front view of a set comprising a connector and a decorative element,

FIG. 2b shows a perspective view of a set comprising a connector and a decorative element,

FIG. 2c shows a front view of a set mounted to a structure, and

FIG. 2d shows a perspective view of a set mounted to a structure.

FIG. 1a shows a front view of a connector 1, the connector 1 in this case being so oriented that the retaining structure 10 occupies substantially the upper half of the surface area F enclosed by the connector 1 (see FIG. 1d in which the dash-dotted line represents the boundary of the surface area F), this substantially also corresponding to the mounted position. In this embodiment the insertion guide 4 is in the form of an uncurved portion 41 angled away from the first leg 6 substantially through 45°. In this case the uncurved portion 41 is arranged at a free end of the wire of the connector 1. The end 42 remote from the free end of the uncurved portion 41 bears in this case resiliently against the second curved portion 82 of the first retaining region 80 of the retaining structure 10.

Starting from the insertion guide 4 the first leg 6 goes into a support region 5 which in this embodiment is in the form of a curvature 51 with a substantially constant radius of curvature and a turn angle of 180°. The support region 5 serves to mount a decorative element 2, as shown for example in FIG. 2a. The curvature 51 serves to minimize the loadings acting on a through hole 12 in a decorative element.

The configuration of the uncurved portion 41 of the insertion guide 4 can be adapted to the configuration of the decorative element 2 or its through hole 12 in order in that way to ensure quick and damage-free application of the decorative element 2 to the connector 1, without using a tool.

In addition adjoining the support region 5 is the second parallel leg 7 which in turn goes into the first retaining region 8 of the retaining structure 10. In this case the first retaining region 8 has a first curved portion 81 and a second curved portion 82 adjoining same by way of an uncurved portion 83. In the embodiment illustrated here the first curved portion 81 is of the same radius of curvature as the curvature 51 of the support region 5. That can provide that the apex points of the first curved portion 81 and the curvature 51 lie on a connecting line substantially parallel to the substantially parallel legs 6, 7 and this therefore can involve a uniform distribution of any longitudinal forces acting on the connector 1 of that configuration. The uncurved portion 83 arranged between the curved portions 81, 82 is of such a configuration that the first retaining region 8 occupies substantially half of the surface area enclosed by the connector 1 (see the area F in FIG. 1d).

In the embodiment of the connector 1 shown here the osculating planes of the curvature 51 and the first curved portion 81 are coplanar in one plane. Together with the length relationships shown here between the straight portions 6, 83 and the straight portion 7 it is possible in that way for the first parallel leg 6 or the end 42 of the insertion guide 4 to bear resiliently against the second curved portion 82 of the first retaining region 8 and thus provide a certain closure safeguard in respect of the connector 1.

The second retaining region 9 of the retaining structure 10 is provided by a portion 91 adjoining the second curved portion 82 by way of an uncurved portion 92, and a free end 11 adjoining the portion 91. The length of the uncurved portion 92 can in this case be so selected that the curved portions 81 and 91 lie as closely together as possible and nonetheless allow the connector to be mounted to the structure 3. In the embodiment illustrated here the curved portion 91 is of a constant radius of curvature and has a turn angle of about 165°. Because the radius of curvature of the second curved portion 82 of the first retaining region 8 is less than the radius of curvature of the first curved portion 81 the second retaining region 9 of the retaining structure 10 is wound in a substantially spiral shape within the first retaining region 8. The radius of curvature of the second curved portion 91 can be so selected that its apex point comes to lie on a connecting line to the apex points of the curvature 51 and the first curved portion 81, whereby this can again result in a desirable distribution of the longitudinal forces acting on the connector 1 in the mounted condition.

By virtue of the provision of a turn angle for the second curved portion 91 of less than 180° it is possible for a free end 11 of the second retaining region 9 to be caused to bear resiliently against the first retaining region 8. In the embodiment illustrated here the free end 11 in this case extends at an angle α out of the connector plane (see the plane E in FIG. 1b). That is shown in FIG. 1c by means of the angle α between the notional planes E and S, which are respectively arranged perpendicularly to the planes of the sheet of paper. Because the free end 11 of the second retaining region 9 extends out of the plane E and bears resiliently against the first retaining region 8 the retaining structure 10 afforded in that way can have a high degree of mechanical closure safeguard against unwanted disengagement of the connector 1 from a structure 3. In this case as shown the free end 11 is in the form of an uncurved portion, adjoining the curved portion 91, of corresponding length.

The advantages of a configuration as described of the connector 1 will be made clear upon visualizing the procedure for mounting the connector 1 to a structure 3. Upon introduction of a substantially one-dimensional portion of a structure 3 into the opening defined by the angled uncurved portion 41 of the insertion guide 4 and the uncurved portion 83 of the first retaining region 8, that results in resilient pivotal opening movement of the first leg 6 and thus opening of the connector 1. When mounting the connector 1 or a set comprising a connector 1 and a decorative element 2 to a structure 3 from below that can be effected by simply pressing the insertion guide 4 against the structure 3 or by a pushing movement against same. The configuration of the second curved portion 82 of the first retaining region 8 and the second leg 7 provides that the retaining structure 10 can be spread open by the part of the structure 3, that now projects through the connector 1, and thus comes to lie at the first curved portion 81 of the first retaining region 8. In the case of an operation as described hereinbefore for mounting the connector 1 to a structure 3 from below, that corresponds to a simple pulling movement. Insertion of the part of the structure 3, that projects through the connector 1, to the second retaining region 9 is effected in a similar manner, except that in this case once again a pushing or pressure movement is required. By virtue of the free end 11 of the second retaining region 9 bearing resiliently against the first retaining region 8 however the second retaining region 9 does not have any device which would facilitate disengagement of the connector 1 from the structure 3. Rather, the situation is such that the illustrated configuration of the retaining structure 10 ensures that the connector 1 remains securely on the structure 3.

FIG. 1b shows a side view of the connector 1, with the direction of view being on to the insertion guide 4 in this case. It will be seen from this view that the support region 5, the first curved region 81, the second curved region 82, the first and second legs 6, 7, the uncurved portions 83 and 92 and also the uncurved portion 41 of the insertion guide 4 lie in a plane E. In other words the osculating planes of the curvature 51 and the first and second curved portions 81, 82 lie in coplanar relationship in a plane E.

FIG. 1c shows a view from above on to the connector, with the direction of view being from above on to the first curved portion 81. Here too it can be seen that in this embodiment the uncurved portion 41 of the insertion guide 4 is in the plane E. The osculating plane of the curved portion 91 of the second retaining region 9 is here identified as the plane S. The free end 11 adjoins the curved portion 91 and is also in the plane S. As can be easily seen from FIG. 1c the plane E includes an angle α with the plane S. The curved portion 91 and the free end 11 adjoining same thus extend out of the plane E. The angle α is so selected in this case that the free end 11 of the second retaining region 9 bears against the first retaining region 8.

FIG. 1d shows a front view of the connector 1, wherein the area enclosed by the clip is identified as the area F and is diagrammatically ordered by a dash-dotted line. In this case the insertion guide 4 is directed outwardly away from the area F.

FIG. 2a shows a set comprising a connector 1 and a decorative element 2. The decorative element 2 is received in the connector 1 and is supported in the support region 5.

FIG. 2b shows a perspective view of a set comprising a connector 1 and a decorative element 2. It will be seen from this perspective view how the connector 1 projects through the through hole 12 in the decorative element and same is supported in the support region 5. The curved configuration of the support region 5 permits minimization of the loadings in the through hole 12 in the decorative element 2.

FIG. 2c shows a front view of a connector fixed to a structure 3, with a decorative element 2 accommodated thereby. The part of the structure 3, that projects through the connector 1, is inserted in this case in the second retaining region 9 of the retaining structure 10 of the connector 1 and is only shown in cross-section. In principle it would also be possible for the structure 10 to be inserted in the first retaining region 8.

FIG. 2d shows a perspective view of a set mounted to a structure 3 and comprising a connector 1 and a decorative element 2.

1. A connector (1) for mounting a decorative element (2) to a structure (3) comprising an insertion guide (4), a support region (5) for the decorative element (2) and a retaining structure (10), wherein two substantially parallel legs (6, 7) adjoin the support region (5), characterised in that the insertion guide (4) projects at a predetermined angle from a first of the two substantially parallel legs (6).

2. A connector as set forth in claim 1 wherein the retaining structure (10) has a plurality of—preferably two—retaining regions (8, 9) for mounting to the structure (3).

3. A connector as set forth in claim 1 wherein the retaining structure (10), the support region (5) and the substantially parallel legs (6, 7) border substantially a closed area (F) and the insertion guide (4) is adapted to project away from that area (F).

4. A connector as set forth in claim 1 wherein the insertion guide (4) has an uncurved portion (41) angled away from the first of the two substantially parallel legs (6) in a range of between 10° and 80°, preferably between 20° and 70° and quite preferably between 30° and 60°.

5. A connector as set forth in claim 1 wherein the second of the substantially parallel legs (7) goes into a first retaining region (8).

6. A connector as set forth in claim 1 wherein the first retaining region (8) has at least a first curved portion (81) and a second curved portion (82) with opposite curvature in relation to the first portion.

7. A connector as set forth in claim 6 wherein arranged between the first curved portion (81) and the second curved portion (82) is an uncurved portion (83) arranged substantially parallel to the substantially parallel legs (6, 7).

8. A connector as set forth in claim 6 wherein the first curved portion (81) of the first retaining region (8) has a curvature with a radius of curvature substantially equal to the radius of curvature of the support region (5) and a turn angle of substantially 180°.

9. A connector as set forth in claim 6 wherein the second curved portion (82) of the first retaining region (8) has a curvature with a radius of curvature less than the radius of curvature of the first curved portion (81) and a turn angle of substantially 180°.

10. A connector as set forth in claim 6 wherein the support region (5) and at least the first curved region (81) of the first retaining region (8) lie substantially in a plane (E).

11. A connector as set forth in claim 10 wherein the second retaining region (9) has a free end (11) extending out of the plane (E).

12. A connector as set forth in claim 1 wherein the second retaining region (9) has a curved portion (91) adjoining the first retaining region (8), preferably by way of an uncurved portion (92).

13. A connector as set forth in claim 1 wherein the second retaining region (9) has a free end (11) which bears resiliently against the first retaining region (8).

14. A connector as set forth in claim 12 wherein the curved portion (91) of the second retaining region (9) has a curvature with a radius of curvature less than the radius of curvature of the second curved portion (82) of the first retaining region (8) and a turn angle of between 90° and 180°.

15. A connector as set forth in claim 1 wherein the end (42) of the insertion guide (4), that is arranged at the substantially parallel leg (6), bears preferably resiliently against the first retaining region (8).

16. A connector as set forth in claim 1 wherein the connector is made from a resilient material, preferably metal.

17. A set comprising a connector (1) as set forth in claim 1 and a decorative element (2), preferably a gemstone.

18. A set as set forth in claim 17 wherein the decorative element (2) has a through hole for mounting the decorative element (2) to the connector (1).

19. An installation, preferably an installation comprising a wire mesh, having at least one set mounted thereto as set forth in claim 17.

20. A connector as set forth in claim 2 wherein the retaining structure (10), the support region (5) and the substantially parallel legs (6, 7) border substantially a closed area (F) and the insertion guide (4) is adapted to project away from that area (F).
